(19) United States
(12) Patent Application Publication
(10) Pub. No.: US 2007/0046118 A1
(43) Pub. Date: Mar. 1, 2007

(54) Shaft sleeve of a DC brushless fan

(75) Inventor: Hsin-Mao Hsieh, Ping Tung City (TW)

Correspondence Address: BACON & THOMAS, PLLC, 625 SLATERS LANE, FOURTH FLOOR, ALEXANDRIA, VA, 22314, US

(73) Assignee: ADDA CORP., Ping Tung City (TW)

(21) Appl. No.: 11/208,601

(22) Filed: Aug. 23, 2005

(51) Int. Cl. H02K 5/16

(52) U.S. Cl. 310/90

(57) ABSTRACT

A shaft sleeve of a DC brushless fan has a cylindrical body, an upper space, a lubricant cavity, a recess, a partition and a longitudinal outer edge. The upper space is formed in the top of the cylindrical body. The lubricant cavity is defined in the cylindrical body and communicates with the upper space. The recess is defined in the bottom. The partition is formed inside of the cylindrical body and between the lubricant cavity and the recess. The longitudinal outer edge is formed around the recess. When the longitudinal outer edge of the shaft sleeve is pressed into a through hole in a frame, a force is generated in the longitudinal outer edge to securely hold the longitudinal outer edge in the frame. Therefore, a strength of a joint between the shaft sleeve and the frame is increased.

### BACKGROUND OF THE INVENTION

1. Field of the Invention

The present invention relates to a shaft sleeve of a DC brushless fan, and more particularly to a shaft sleeve of a DC brushless fan having a lubricant cavity and a recess used to rivet the shaft sleeve to a base of a fan.

2. Description of Related Art

With reference to FIG. 8, a common conventional DC brushless fan has a frame (70), a shaft sleeve (80), a retaining ring (53), a lubricant chamber (81), a bearing (52), a PCB (82), a stator (40), a fan casing (50) and a rotor (55).

The frame (70) has an outer ring (71), an inner ring (72) and an annular slot (711). The inner ring (72) has a top edge (not numbered). The annular slot (711) is defined between the outer and inner rings (71, 72).

The shaft sleeve (80) has a bottom section (not numbered), a middle section (not numbered) and an upper section (not numbered). The bottom section is pressed into the annular slot (711) to form a joint (not numbered) with the inner ring (72) inside the bottom section of the shaft sleeve (80).

The retaining ring (53) has a central through hole (not numbered) and is mounted in the shaft sleeve (80) on the top edge of the inner ring (72).

The lubricant chamber (81) is defined and enclosed by the retaining ring (53), the inner ring (72) and the frame (70) in the bottom segment of the shaft sleeve (80).

The bearing (52) is mounted inside the middle segment of the shaft sleeve (80) and has a central through hole (not numbered).

The PCB (82) has a through hole (not numbered) and is mounted on the frame (70) around the bottom segment of the shaft sleeve (80).

The stator (40) is mounted on the frame (70) around the middle segment of the shaft sleeve (80).

The fan casing (50) is mounted rotatably around the stator (40) and has a central shaft (51), a central cavity (not numbered) and multiple fan blades (not numbered). The central shaft (51) is pressed into and extends down from the central cavity of the fan casing (50), is mounted rotatably through the bearing (52) in the shaft sleeve (80) and the through hole in the retaining ring (53) and has a bottom neck (511). The bottom neck (511) corresponds to the through hole in the retaining ring (53).

The rotor (55) is mounted inside the fan casing (50) and corresponds to the stator (40) around the shaft sleeve (80).

To ensure that the fan operates smoothly, lubricant is added to the shaft sleeve (80) and held in the lubricant chamber (81) to lubricate the central shaft (51).

The stator (40) and the fan casing (50) with the rotor (55) are mounted on the shaft sleeve (80), so a total weight of the shaft sleeve (80) is heave. In addition, when the fan casing (50) is operating, a larger pressure is supplied to the joint of the shaft sleeve (80) and the frame (70). Therefore, the strength of the joint must be large enough to support the weight and the pressure of the shaft sleeve (70). However, the shaft sleeve (80) is only pressed into the frame (70), so the strength should be increased to ensure that the fan has a stable useful life.

The present invention provides a shaft sleeve to increase the strength of the joint between the frame and the shaft sleeve.

### SUMMARY OF THE INVENTION

The main objective of the present invention is to provide a shaft sleeve of a DC brushless fan that increases the strength of the joint between the shaft sleeve and the frame of the fan.

A shaft sleeve of a DC brushless fan in accordance with the present invention is mounted in a through hole in a frame of a brushless fan and has a cylindrical body, an upper space, a lubricant recess, a lower opening, a partition and a circular edge. The cylindrical body has a top and a bottom. The upper space is formed on the top of the cylindrical body. The lubricant cavity is defined in the cylindrical body and communicates with the upper space. The recess is defined in the bottom. The partition is formed inside the cylindrical body between the lubricant cavity and the lower opening. The circular edge is formed around the lower opening. When the circular edge of the shaft sleeve is pressed into the through hole in the frame, an external pressing force is applied horizontally to the circular edge. Therefore, the joint between the shaft sleeve and the frame is strong. In addition, the shaft sleeve does not use the frame or other external elements to hold the lubricant in the lubricant cavity.

Other objectives, advantages and novel features of the invention will become more apparent from the following detailed description when taken in conjunction with the accompanying drawings.

### BRIEF DESCRIPTION OF THE DRAWINGS

FIG. 1 is a cross sectional side view of a first embodiment of a shaft sleeve in accordance with the present invention;

FIG. 2 is a cross sectional side view of a DC brushless fan with the shaft sleeve of FIG. 1;

FIG. 3 is an enlarged cross sectional side view of the shaft sleeve in FIG. 1 in the DC brushless fan in FIG. 2;

FIG. 4 is a cross sectional side view of a second embodiment of a shaft sleeve in accordance with the present invention;

FIG. 5 is an exploded perspective view of the shaft sleeve of FIG. 4 and a base of a DC brushless fan;

FIG. 6 is a cross sectional side view of a DC brushless fan with the shaft sleeve of FIG. 4;

FIG. 7 is an exploded perspective view of a third embodiment of an shaft sleeve in accordance with the present invention and a base of a DC brushless fan; and

FIG. 8 is a cross sectional side view of a conventional DC brushless fan in accordance with the prior art.

### DETAILED DESCRIPTION OF THE PREFERRED EMBODIMENT

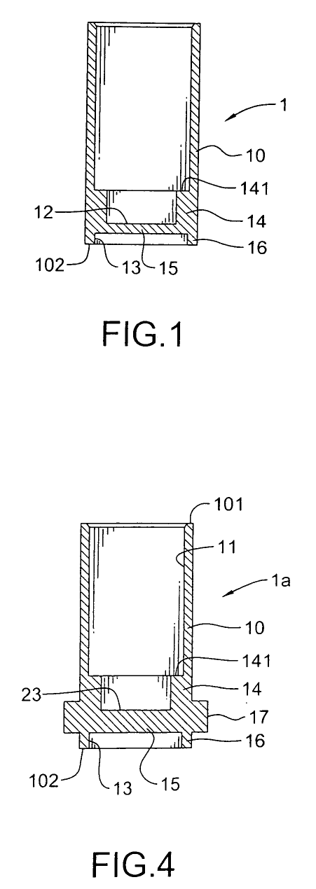

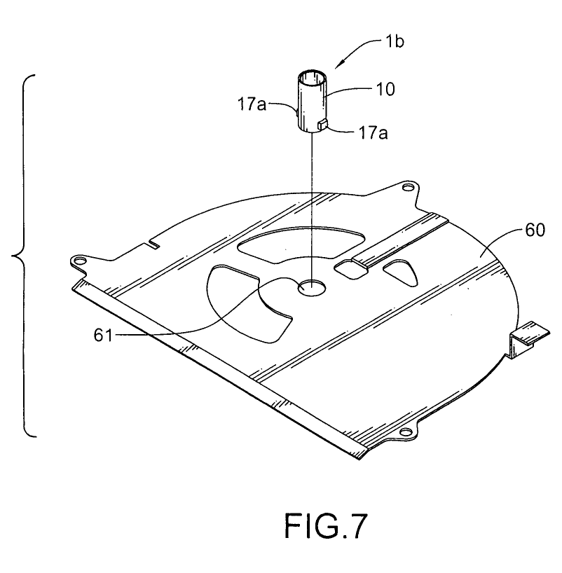

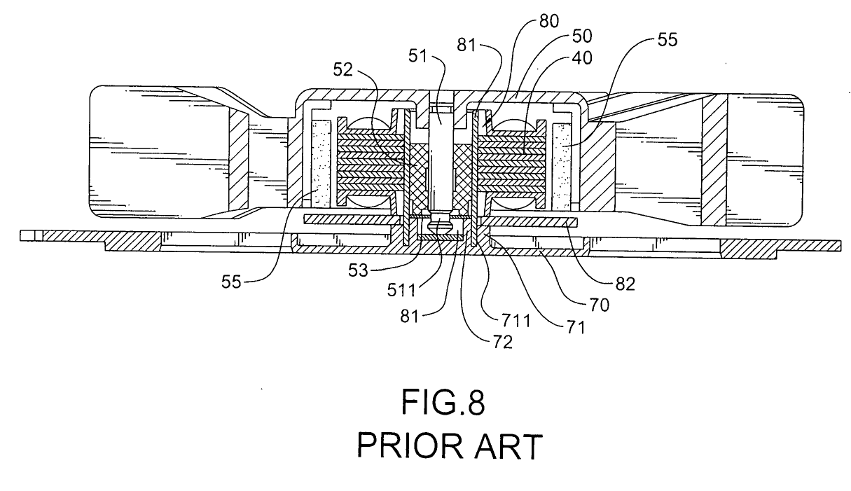

With reference to FIGS. 1, 4 and 7, a shaft sleeve (1, 1a) in accordance with the present invention has a cylindrical body (10), an upper space (11), a lubricant cavity (12), an inner shoulder (14), a recess (13), a longitudinal outer edge (16) and an optional protruding annular ring (17) or at least two radial protrusions (17a).

The cylindrical body (10) has a top (101) and a bottom (102).

The upper space (11) is defined in the top (101) of the cylindrical body (10) and has an inside diameter.

The lubricant cavity (12) is defined in the cylindrical body (10), communicates with the upper space (11) at a junction between the lubricant cavity (12) and the upper space (11) and has an inside diameter. The inside diameter of lubricant cavity (12) is smaller than the upper space (11).

The inner shoulder (14) is formed inside the cylindrical body (10) at the junction between the lubricant cavity (12) and the upper space (11) and has a top face (141). The top face (141) faces the upper space (11).

The recess (13) is defined coaxially in the bottom (102) of the cylindrical body (10).

The partition (15) is formed inside the cylindrical body (10) between the lubricant cavity (12) and the recess (13).

The longitudinal outer edge (16) is formed at the bottom (102) of the cylindrical body (10) around the recess (13).

The protruding annular ring (17) is formed around and protrudes radially out from the cylindrical body (10) and corresponds to the partition (15).

The radial protrusions (17a) are formed around and protrude radially out from the cylindrical body (10) and correspond to the partition (15).

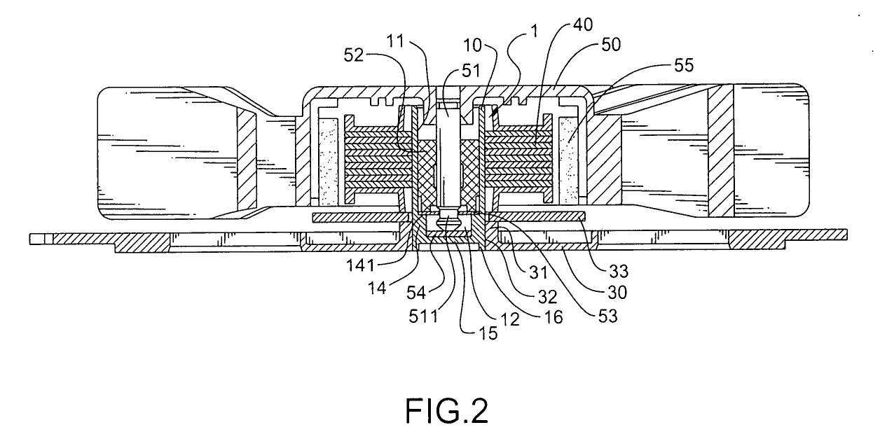

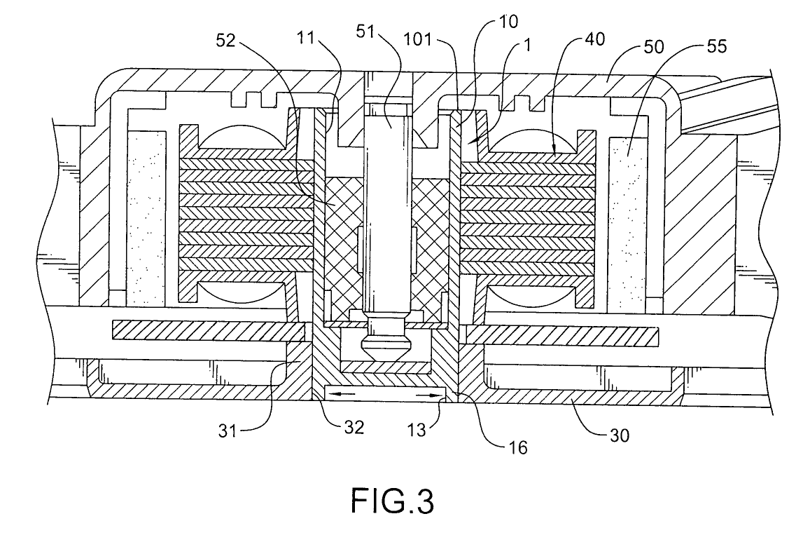

With further reference to FIGS. 2 and 3, the shaft sleeve (1, 1a) is used to assemble to a DC brushless fan (not numbered). The DC brushless fan has a frame (30), a retaining ring (53), a pad (54), a bearing (52), a stator (40), a PCB, (33), a rotor (55) and a fan casing (50). The frame (30) has a mounting ring (31) and a mounting hole (32). The mounting hole (32) is defined through the frame (30) concentrically in the mounting ring (31). First, the shaft sleeve (1, 1a) is pressed into the mounting hole (32), and the longitudinal outer edge (16) is pressed inside the mounting ring (31). Compressing the longitudinal outer edge (16) into the mounting ring (31) causes a reactive force (arrowheads in FIG. 3) to be generated in press the longitudinal outer edge (16) against the mounting ring (31) of the frame (30). Therefore, the longitudinal outer edge (16) is attached to the mounting ring (31) of the frame (30) more securely than that the joint of the conventional shaft sleeve and the bottom of the frame.

When the shaft sleeve (1) is mounted securely in the frame (30), the pad (54) is mounted in the lubricant cavity (12) on the partition (15). The retaining ring (53) is mounted in the upper space (11) on the top face (141) of the inner shoulder (14). The bearing (52) is mounted securely in the upper space (11) against the retaining ring (53). The stator (40) and the PCB (33) are mounted outside the cylindrical body (10). The center shaft (51) of the fan casing (50) is mounted in the cylindrical body (10) through the bearing (52) and the retaining ring (53). The neck (511) of the central shaft (51) is pressed into the retaining ring (53).

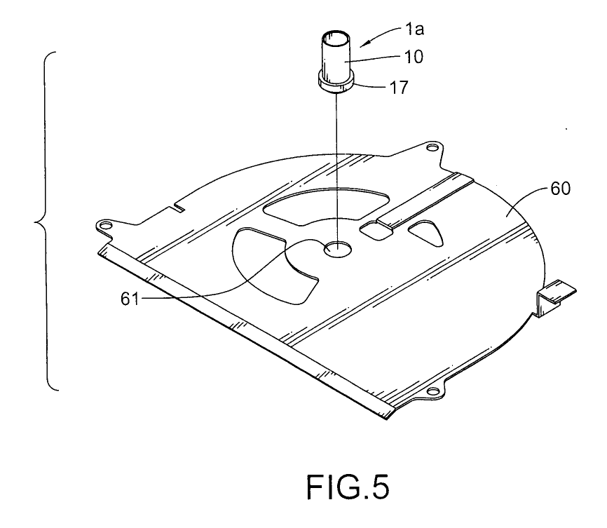

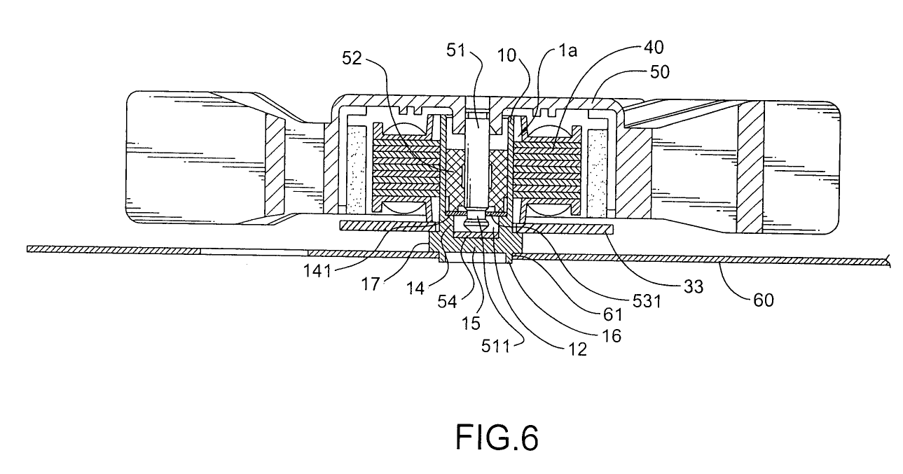

The protruding annular ring (17) or radial protrusions (17a) attach to another frame (60). With further reference to FIGS. 5 and 6, the frame (60) has one through hole (61), and the protruding annular ring (17) or radial protrusions (17a) are a limit and are pressed against a top surface (not numbered) of the frame (60) when the longitudinal outer edge (16) is pressed into the through hole (61). The radial force generated in the longitudinal outer edge (16) holds the shaft sleeve (la) securely on the frame (60). Therefore, the strength of the joint of the cylindrical body (10) and the frame (60) is increased.

Furthermore, the shaft sleeve (1, 1a) has its own lubricant cavity (12), so lubricant can be held in the lubricant cavity.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A shaft sleeve of an DC brushless fan, comprising:
a cylindrical body having a top and a bottom;
an upper space defined in the top and having an inside diameter;
a lubricant cavity defined in the cylindrical body, communicating with the upper space at a junction between the lubricant cavity and the upper space and having an inside diameter that is smaller than the inside diameter of the upper space;
an inner shoulder formed inside the cylindrical body at the junction between the lubricant cavity and the supper space and having a top face facing the upper space;
a recess defined coaxially in the bottom of the cylindrical body;
a partition formed inside the cylindrical body between the lubricant cavity and the recess; and
a longitudinal outer edge formed at the bottom of the cylindrical body around the recess.

2. The shaft sleeve as claimed in claim 1, further comprising a protruding annular ring formed around and protruding radially out from the cylindrical body and corresponding to the partition.

3. The shaft sleeve as claimed in claim 1, further comprising at least two radial protrusions formed around and protruding radially out from the cylindrical body and corresponding to the partition.
